(19) United States
(12) Patent Application Publication
(10) Pub. No.: US 2021/0387192 A1
(43) Pub. Date: Dec. 16, 2021

(54) PURITY DETECTION OF SEPARATED SAMPLE PORTION AS BASIS FOR A POSITIVE OR NEGATIVE DECISION CONCERNING FURTHER SEPARATION

(71) Applicant: Agilent Technologies, Inc., Santa Clara, CA (US)

(72) Inventor: Ulrich Eberhardinger, Karlsruhe (DE)

(21) Appl. No.: 17/347,461

(22) Filed: Jun. 14, 2021

(30) Foreign Application Priority Data
Jun. 15, 2020 (GB) 2009052.8

(51) Int. Cl. B01L 3/00; G01N 30/02

(52) U.S. Cl. CPC B01L 3/502753; G01N 30/02; B01L 2400/06; G01N 2030/027; B01L 2300/14; B01L 2300/0896; B01L 2400/0487

(57) ABSTRACT

A sample separation apparatus for separating a fluidic sample includes an initial dimension sample separation device configured for separating the fluidic sample, a subsequent dimension sample separation device configured for further separating separated fluidic sample received from the initial dimension sample separation device, a purity detector configured for detecting information indicative of a purity of a portion of the fluidic sample which has been separated by the initial dimension sample separation device, and a control unit configured for controlling, depending on the detected information, whether or not further separation of the portion of the fluidic sample which has been separated by the initial dimension sample separation device is carried out by the subsequent dimension sample separation device.

### RELATED APPLICATIONS

This application claims priority to UK Application No. GB 2009052.8, filed Jun. 15, 2020, the entire contents of which are incorporated herein by reference.

### TECHNICAL FIELD

The present invention relates to a sample separation apparatus and a method of separating a fluidic sample.

### BACKGROUND

In liquid chromatography, a fluidic sample, and an eluent (liquid mobile phase) may be pumped through conduits and a column in which separation of sample components takes place. The column may comprise a material which is capable of separating different components of the fluidic analyte. Such a packing material, so-called beads which may comprise silica gel, may be filled into a column tube which may be connected to other elements (like a control unit, containers including sample and/or buffers) by conduits. The composition of the mobile phase can be adjusted by composing the mobile phase from different fluidic components with variable contributions.

Two-dimensional separation of a fluidic sample denotes a separation technique in which a first separation procedure in a first separation unit is performed to separate a fluidic sample into a plurality of components, and in which a subsequent second separation procedure in a second separation unit is performed to further separate the plurality of components into sub-components. Two-dimensional liquid chromatography (2D LC) may thus combine two liquid chromatography separation techniques.

Danilo Sciarrone, Sebastiano Pantò, Paola Donato, Luigi Mondello, “Improving the productivity of a multidimensional chromatographic preparative system by collecting pure chemicals after each of three chromatographic dimensions”, Journal of Chromatography A, 1475 (2016) 80-85, discloses an enhanced sample collection capability of a heart-cutting three-dimensional gas chromatography preparation system with the feasibility to collect pure components after each chromatographic dimension. A three-dimension gas chromatography system is provided which is equipped with high-temperature valves, located inside the first and second gas chromatography ovens, with the aim to improve the productivity of the collection procedure. Two laboratory-made collection systems are applied in the first and second dimension, reached by the effluent to be collected through a high-temperature valve switching the heart-cutting fraction between either the detector, or the collector.

However, conventional multidimensional sample separation measurement may be still time-consuming and cumbersome for a user.

### SUMMARY

It is an object of the invention to enable accurate sample separation in a short time and with low effort for a user.

According to an exemplary embodiment of the present invention, a sample separation apparatus for separating a fluidic sample is provided, wherein the sample separation apparatus comprises an initial dimension (or primary stage) sample separation device configured for separating the fluidic sample, a subsequent dimension (or secondary stage) sample separation device configured for further separating separated fluidic sample received from the initial dimension sample separation device, a purity detector configured for detecting information indicative of a purity of a portion of the fluidic sample which has been separated by the initial dimension sample separation device, and a control unit configured for controlling, depending on the detected information concerning purity, whether or not further separation of the portion of the fluidic sample which has been separated by the initial dimension sample separation device is carried out or is not carried out by the subsequent dimension sample separation device.

According to another exemplary embodiment of the present invention, a method of separating a fluidic sample is provided, wherein the method comprises separating the fluidic sample, detecting information indicative of a purity of a portion of the separated fluidic sample, and controlling, depending on the detected information, whether or not further separation of the portion of the separated fluidic sample will be carried out.

In the context of this application, the term “sample separation apparatus” may particularly denote any apparatus which is capable of separating different components of a fluidic sample by applying a certain separation technique. Particularly, two separation units may be provided in such a sample separation apparatus when being configured for a two-dimensional separation. This means that the sample is first separated in accordance with a first separation criterion, and is subsequently separated in accordance with a second, preferably but not necessarily different, separation criterion. In other words, the first and the second separation criteria may be different (in particular may be orthogonal) or may be the same.

In the context of this application, the term “fluidic sample” may particularly denote any liquid and/or gaseous medium, optionally including also solid particles, which is to be analyzed. Such a fluidic sample may comprise a plurality of components of molecules or particles which shall be separated, for instance biomolecules such as proteins. Since separation of a fluidic sample into components involves a certain separation criterion (such as mass, volume, chemical properties, etc.) according to which a separation is carried out, each separated component may be further separated by another separation criterion (such as mass, volume, chemical properties, etc.), thereby splitting up or separating a separate component into a plurality of sub-components. In the context of this application, the term “component” may particularly denote such a group of molecules or particles of a fluidic sample which have a certain property (such as mass, volume, chemical properties, etc.) in common according to which the separation has been carried out. However, molecules or particles relating to one component can still have some degree of heterogeneity, i.e. can be further separated in accordance with another separation criterion. In the context of this application, the term “sub-components” may particularly denote individual groups of molecules or particles all relating to a certain component which still differ from one another regarding a certain property (such as mass, volume, chemical properties, etc.). Hence, applying another separation criterion for the second separation as compared to the separation criterion for the first separation allows these groups to be further separated from one another by applying the other separation criterion, thereby obtaining the further separated sub-components.

In the context of this application, the term “initial and subsequent dimension sample separation device” may particularly denote that at least two serially connected sample separation devices are provided which constitute two consecutive dimensions of sample separation. Firstly, the fluidic sample is separated in the sample separation device of the initial dimension (for instance a primary separation stage). Thereafter, the separated sample may be—under specific circumstances—further separated in the other sample separation device of the subsequent dimension (for instance a secondary separation stage). For example, the initial dimension sample separation device may be a primary sample separation device and the subsequent dimension sample separation device may be a secondary stage sample separation device. In an embodiment relating to two-dimensional sample separation, the initial dimension sample separation device may be a first dimension sample separation device and the subsequent dimension sample separation device may be a second dimension separation device.

In the context of this application, the term “purity detector” may particularly denote any physical entity suitable or configured for detecting or sensing information whether or not a portion of fluidic sample (such as a section, plug or packet of fluidic sample flowing through a conduit or other fluidic member of the sample separation apparatus) has only or substantially only a single component or is composed of multiple different components which can be further separated. In other words, a purity detector may provide information as to whether a portion of fluidic sample consists of a single species in a mobile phase, i.e. is pure, or is a mixture of multiple species in the mobile phase, i.e. is not pure. A fluidic sample portion which is not yet pure can be further separated into its individual sub-components or species in a subsequent dimension sample separation device.

In the context of this application, the term “control unit” may particularly denote any entity of a sample separation apparatus deciding whether or not already separated fluidic sample proceeds to further separation or is not further separated. For example, such a control unit may be a processor (or multiple processors or part of a processor) having processing capability and being configured for processing an output of the purity detector to thereby control the sample separation apparatus concerning further processing of the separated fluidic sample. Hence, the control unit may use the detected purity information to make the decision whether the already separated fluidic sample portion is further separated (namely when it is already sufficiently pure), or is treated otherwise rather than being further separated (namely when it is not yet sufficiently pure). The control unit may be, or be part of, a computing device comprising one or more electronics-based processors, memories, user interfaces for input and/or output, and the like as appreciated by persons skilled in the art.

According to an exemplary embodiment of the invention, a sample separation system is provided which may flexibly decide after a separation of fluidic sample whether or not the separated fluidic sample, and in particular a specific portion thereof, shall be further separated. The decision as to whether further separation of a separated fluidic sample portion shall be executed or not may be taken depending on an output of a purity detector providing information about the purity of the portion of the fluidic sample after its previous or initial separation. If the sample is considered as already sufficiently purified after the first separation in view of the information provided by the purity detector, no further separation of the separated fluidic sample in the subsequent separation dimension is necessary. In this scenario, a further measure can be taken, such as a fractionation of the separated fluidic sample portion, or a termination of the sample separation operation concerning this specific fluidic sample portion. If however the output of the purity detector is that the already separated sample portion is still a mixture of multiple heterogeneous sub-components or species, it can be controlled that the already separated fluidic sample portion is further separated in a further separation dimension. With such a controlled architecture it can be ensured that the fluidic sample is properly separated while simultaneously ensuring that unnecessary operation time of the sample separation apparatus (trying to further separate an already sufficiently separated fluidic sample in a further separation dimension) can be avoided. Thus, a high separation performance can be combined with a quick, efficient, and user-friendly separation. Advantageously, this decision can be taken individually and differently for different portions of the separated fluidic sample in an automated and objective manner. High efficiency, high flexibility and high accuracy can thereby be synergistically combined. Further advantageously, the purity analysis and decision-making can be integrated in-line in the sample separation procedure so that the system can operate in real time and without the need of a user intervention.

In the following, further exemplary embodiments of the sample separation apparatus and the method will be explained.

In an embodiment, the control unit may control or trigger a further separation of said portion of the fluidic sample if an insufficient purity level has been detected by the purity detector for said portion of the fluidic sample (preferably in an in-line process). Moreover, the control unit may control or trigger that said portion of the fluidic sample is drained off away from a further separation path relating to the subsequent stage sample separation device without a further separation if a sufficient purity level has been detected for said portion of the fluidic sample by the purity detector. In other words, the decision for the execution or for the omission of a further separation can be made by the control unit based on a result of the purity detection.

In an embodiment, the method comprises forwarding at least one separated portion of the fluidic sample to a further separation path for carrying out a further separation, and draining at least one other separated portion of the fluidic sample away from the further separation path without a further separation, depending on a respective detected purity level of said separated portions of the fluidic sample. Thus, depending on different purity levels detected for different portions of the same continuously processed fluidic sample, the control unit may make different selections to carry out a further separation in a subsequent sample separation device for one or more multi-component portions of the separated fluidic sample while disabling such a further separation in a subsequent sample separation device for one or more already sufficiently pure portions of the fluidic sample.

In an embodiment, the purity detector is configured for detecting whether the separated portion of the fluidic sample comprises only one pure component or is composed of multiple components. In the former case, a further separation in a subsequent dimension may be dispensable, whereas in the latter case a respective portion of the already separated fluidic sample may proceed to a subsequent separation dimension for being further separated. The decision as to whether a separated portion at an outlet of the initial dimension sample separation device can be considered as pure (or at least sufficiently pure), or as a mixture of multiple components can be taken based on an analysis of a detection spectrum measured after the initial dimension separation.

In an embodiment, the purity detector is configured for detecting whether the separated portion of the fluidic sample comprises only one pure component or is composed of multiple components by detecting a chromatogram. A chromatogram may be denoted as a detector diagram obtained after a chromatographic separation of the fluidic sample in the initial dimension sample separation device. A chromatogram may show one or multiple peaks over time, each peak corresponding to an assigned component of the fluidic sample. In other words, a chromatogram is a visual output of a chromatograph. In the case of an optimal separation, different peaks or patterns on the chromatogram correspond to different components of the separated mixture. Hence, the initial dimension sample separation may be a chromatographic separation, in particular a liquid chromatography or gas chromatography separation.

In an embodiment, a respective separated portion of the fluidic sample may correspond to an optical peak in a diagram plotting the results of the separation, in particular an absorption peak and/or a single optical peak. For example, the purity detector may comprise a UV detector or fluorescence detector with a light source and a light detector, wherein detection light may propagate through a flow cell through which the separated sample flows. In the purity detector, absorption of light by the fluidic sample may be measured as an absorption peak. Additionally or alternatively, it is also possible to measure a transmission characteristic of light. Wavelengths of detection light may be in the visible range, in the ultraviolet range and/or in the infrared range. A detector may be anyway present in a multi-dimensional (in particular two-dimensional) sample separation device at an output of an initial dimension sample separation device for detecting separated components of the fluidic sample, and said detector may be synergistically used as purity detector providing an output as a basis for a decision as to whether a further separation shall be carried out or not.

In an embodiment, the purity detector is configured for detecting the information by further analyzing the optical peak. The shape or time resolution of the optical peak may be further analyzed for assessing as to whether the peak is a single species peak or comprises contributions from multiple different species. A corresponding further analysis of an optical peak may include a shape analysis, a fit (for instance a least-squares fit), and/or a detection of further sensor data relating to the identified peak.

In an embodiment, the purity detector is configured for further analyzing the optical peak by recording and comparing a plurality of characteristic curves all relating to the optical peak by varying at least one physical parameter (in particular a detection wavelength of a fluorescence detector) over time. The optical peak may be indicative of an optical property (such as absorption or transmission) over time, i.e. while a separated portion of the fluidic sample passes the purity detector. Each of the multiple characteristic curves may relate to a variation of a physical parameter at an assigned point of time of the optical peak. For instance, the variable physical parameter may be a variable wavelength so that each characteristic curve may be a wavelength spectrum, i.e. wavelength over intensity. Each characteristic curve may relate to a specific point of time of the optical peak. After having captured said characteristic curves, they may be compared with respect to one or more criteria for determining as to whether the different characteristic curves are the fingerprint of a single species fluidic sample portion or of a multiple species fluidic sample portion. For instance, at least three different characteristic curves may be analyzed. It is however also possible that the number of characteristic curves is significantly larger, for instance up to 200. In an embodiment, the number of analyzed characteristic curves may be in the range from 5 to 100. The number of analyzed characteristic curves may be determined on the one hand based on a desired level of accuracy of the determination of the number of species in a portion of the fluidic sample, and on the other hand based on an available time interval of the optical peak versus a measurement time for capturing a respective characteristic curve.

In an embodiment, the purity detector is configured for assuming purity of the portion of the separated fluidic sample if the plurality of characteristic curves differ concerning their shapes by less than a predefined threshold. In particular, sufficient purity of the separated portion of the fluidic sample may be assumed if the various characteristic curves show a fixed mutual proportion within a predefined accuracy range, i.e. can be converted into each other by multiplication with a factor (optionally in combination with an offset or baseline correction). In a scenario in which only one component is present in the separated portion of the fluidic sample, the various characteristic curves may have different amplitudes but the same shape. If however multiple different components are present in the separated portion of the fluidic sample, the shape or profile of the different characteristic curves may also be different. The determination as to whether one or multiple components is/are present in the portion of the fluidic sample may be estimated on the basis of a comparison of the properties of the various characteristic curves, for instance on the basis of image recognition, fits and/or elements of artificial intelligence.

In another embodiment, the purity detector is configured for further analyzing the optical peak by recording one or more characteristic curves relating to the optical peak by varying at least one physical parameter (in particular a detection wavelength of a fluorescence detector) over time and by comparing the characteristic curve with a reference curve relating to a reference sample with pre-known properties. When the fluidic sample comprises for example one or more preknown substances, the knowledge of the characteristics of such substances in detection curves may be stored in the form of one or more reference curves in a database, for instance on a mass storage device. A comparison of such reference curves with the actually detected one more characteristic curves may then allow to determine whether the separated portion of the fluidic sample comprises multiple species or only a single species.

In an embodiment, the purity detector is a non-destructive detector configured for analyzing the fluidic sample without destructing the fluidic sample. A non-destructive purity detector may be denoted as a detector which does not destroy the fluidic sample during the purity detection. For example, a fluorescence detector is non-destructive. The implementation of a non-destructive detector maintains integrity of the fluidic sample so that exactly the same identical portion of the fluidic sample which has been subject to the purity detection may be subsequently further separated, if desired. Hence, the reliability of the purity detection and the corresponding decision about a further separation can be further improved when the portion of the fluidic sample used for the purity detection and the portion of the fluidic sample made subject to the further separation are identical.

In an embodiment, the purity detector comprises a spectral analysis detector configured for carrying out a spectral analysis with the portion of the fluidic sample. Such a spectral analysis detector is an example for a non-destructive detector and may detect an intensity over wavelength characteristic. It has turned out that by a spectral analysis, the determination of the presence of one or multiple components in an already separated portion of the fluidic sample may be identified with high accuracy. For instance, a spectral analysis detector may be embodied as a fluorescence detector with light source, light detector, and a flow cell through which the separated portion of the fluidic sample flows and is detected during flowing.

In a fluorescence detector, for instance, incident light may interact with a separated portion of the fluidic sample. Photons emitted by the separated portion of the fluidic sample can be detected at different wavelengths. Fluorescence detectors may excite fluorophores of the separated portion of the fluidic sample with a specific wavelength (which may be selected for example with a filter or a monochromator), and may then monitor emission at a different (in particular longer) wavelength selected with another filter or monochromator. Excitation light may be removed by the second filter or monochromator, allowing only the emitted light to strike a transducer of the fluorescence detector. Preferably, interfering components are not detected because they do not absorb at the chosen excitation wavelength and/or do not emit at the chosen emission wavelength. Fluorescence detectors can be used in series with a variable wavelength UV (ultraviolet light) detector, so both signals can be monitored for further improved sensitivity and selectivity.

In another embodiment, the purity detector comprises a mass spectrometry detector configured for further analyzing at least a part the portion of the fluidic sample by mass spectrometry concerning purity (wherein said part may be destroyed during mass spectrometry analysis). Another part of the portion of the fluidic sample may be forwarded (without mass spectrometry analysis) for further separation to the subsequent dimension sample separation device if the purity detector detects an insufficient purity level for the portion of the fluidic sample. Mass spectrometry is an analytical technique that measures the mass-to-charge ratio of ions. The result may be presented as a mass spectrum, a plot of intensity as a function of the mass-to-charge ratio. Mass spectrometry may be used as a powerful tool to distinguish pure samples from complex mixtures. Although mass spectrometry is a destructive method, it may be applied in the context of exemplary embodiments of the invention by implementing a flow splitter which splits a respective portion of the fluidic sample into a first flow and a second flow. The first flow may be directed into the mass spectrometry detector for analyzing the number of components in the separated portion of the fluidic sample. Depending on the results of said detection, the second flow may or may not be further separated in the subsequent dimension sample separation device. With the implementation of such a flow splitter, the “separation decision depending on purity detection” concept of exemplary embodiments of the invention may also be implemented in the context of a destructive detector, such as a mass spectrometry detector.

In an embodiment, the purity detector is configured for detecting components of the fluidic sample separated by the initial dimension sample separation device. Hence, the purity detector may be synergistically used also for detecting the various components separated in the first separation dimension. This keeps the sample separation apparatus contact.

In an embodiment, the control unit is configured for triggering further separation of the separated fluidic sample in the subsequent dimension sample separation device if the detected information is indicative of the presence of a plurality of components in the detected portion of the fluidic sample. For instance, the control unit may control the sample separation apparatus for directing the separated portion of the fluidic sample into the subsequent separation dimension for further separation, when the purity detection has indicated that the already separated portion of the fluidic sample still comprises multiple components or fractions.

In an embodiment, the control unit is configured for discharging the portion of fluidic sample out of the sample separation apparatus (in particular for fractionating the portion of the fluidic sample) without further separation of the separated fluidic sample in the subsequent dimension sample separation device if the detected information is indicative of a purity of the detected portion of the fluidic sample. Hence, the control unit may prevent forwarding of the separated portion of the fluidic sample into the next separation dimension when the purity detection has shown that the separated portion of the fluidic sample is already sufficiently pure and needs no further separation. This saves time and resources without compromising on the separation accuracy.

In an embodiment, the control unit is configured for controlling in-line whether or not further separation of the already separated fluidic sample by the subsequent dimension sample separation device is carried out or not. In the context of the present application, the term “in-line” analysis may particularly denote a continuous process control, without manual sampling followed by discontinuous sample preparation, measurement, and evaluation. In in-line analysis, the material properties of the fluidic sample portion cannot change in the time interval between purity detection of a separated fluidic sample portion and forwarding said separated fluidic sample portion to a further separation in a subsequent separation stage, so direct process control is possible. Thus, the decision concerning the necessity of a further separation of a portion of fluidic sample in a subsequent separation dimension may be made in real time and based on a purity detection which is made on exactly the same sample material which is later further separated. Highly advantageously, this makes it possible that the physically same sample is analyzed in the purity detector which is, if desired or required, further separated in the subsequent separation dimension. This physical identity may avoid artefacts and may speed up the fluid processing.

In an embodiment, the control unit is configured for operating the sample separation apparatus in a heart-cutting mode, in particular in a multiple heart-cutting mode. In a heart-cutting mode, only a subsection of fluidic sample separated in the initial separation dimension is further separated in the subsequent separation dimension. In a multiple heart-cutting mode, only a number of subsections of fluidic sample, but not the entire fluidic sample, separated in the initial separation dimension is further separated in the subsequent separation dimension. In contrast to this, in a comprehensive mode, the entire fluidic sample is further separated in a subsequent separation stage.

Advantageously, a heart-cutting mode may be reliably controlled using the output of the purity detector.

In an embodiment, the sample separation apparatus is configured as two-dimensional sample separation apparatus, i.e. a sample separation apparatus having exactly two separation dimensions. For instance, the sample separation apparatus may be configured as two-dimensional chromatographic sample separation apparatus, i.e. carrying out the sample separation on the basis of chromatography. In chromatography, sample separation is accomplished by adsorbing various components of the fluidic sample at a stationary phase and subsequently desorbing, one after the other, the components of the fluidic sample from the stationary phase. For example, exemplary embodiments may be implemented in terms of liquid chromatography or gas chromatography.

In an embodiment, the sample separation apparatus comprises at least one further dimension sample separation device, in particular at least one further dimension chromatographic sample separation device, configured for further separating the fluidic sample in at least one further separation dimension. For example, the sample separation apparatus may be configured with three or more separation dimensions or stages. Between each two adjacent sample separation devices, a respective purity detector may be arranged for deciding as to whether the continued sample separation in the respectively next separation stage shall be carried out or not. Between each two adjacent sample separation devices, this decision can be taken individually (and also differently) for different portions of the fluidic sample (see for instance FIG. 7).

In an embodiment, the sample separation apparatus is configured as one of an analytic sample separation apparatus and a preparative sample separation apparatus. The purpose behind a chromatography run may be analytical or preparative. In analytical chromatography the purpose is to separate the components of the sample. Here, the focus is on analyzing a substance in detail and gathering information about it. This in turn can provide a qualitative profile or fingerprint of the sample. The purpose of preparative chromatography, on the other hand, is isolation and purification of reasonably sufficient quantities of a specific substance from the sample. In particular analytic sample separation may be carried out highly advantageously by exemplary embodiments.

In an embodiment, the sample separation apparatus comprises a sampling valve, modulator valve or fluid valve connected to an outlet of the initial dimension sample separation device and connected to an inlet of the subsequent dimension sample separation device, wherein the control unit is configured for switching the sampling valve depending on the detected purity information. In the context of this application, the term “fluidic valve” may particularly denote a fluidic component which has fluidic interfaces, wherein upon switching the fluidic valve selective ones of the fluidic interfaces may be selectively coupled to one another so as to allow fluid to flow along a corresponding fluidic path, or may be decoupled from one another, thereby disabling fluid communication. Switching of the sampling valve at an interface between the two consecutive separation stages under control of the control unit may define whether the already separated portion of the fluidic sample will proceed for a further refined separation in the subsequent separation stage of whether said portion of the fluidic sample is not made subject to a further refined separation. In the former case, the portion of the fluidic sample may flow through the sampling valve into a flow path between a fluid drive unit and a separation unit of the subsequent dimension sample separation device. In the latter case, the portion of the fluidic sample may flow through another path of the sampling valve, for instance towards a fractionating unit or to a drain or waste line.

In an embodiment, the sampling valve comprises at least one sample accommodation volume (for instance a sample loop), preferably a plurality of sample accommodation volumes, configured for temporarily accommodating or buffering a portion of the fluidic sample after separation by the initial dimension sample separation device and before separation by the subsequent dimension sample separation device. By providing multiple sample accommodation volumes as buffer volumes (see FIG. 2 and FIG. 8) between the two consecutive separation dimensions, delay times may be kept small and a substantially continuous sample separation may be carried out. For instance, at a certain point of time, one sample accommodation volume may fill in a portion of fluidic sample while at the same point of time another sample accommodation volume is in a separation path between a fluid drive unit and a sample separation unit of the subsequent dimension sample separation device. By switching the sampling valve, the function of the mentioned sample accommodation volumes may be exchanged, and so on. This substantially continuous operation of multiple sample accommodation volumes may synergistically cooperate with the purity-based selection of a number of used separation stages for accelerating sample separation.

In an embodiment, the initial dimension sample separation device comprises an initial dimension fluid drive unit (such as a high-pressure mobile phase pump) configured for driving mobile phase and the fluidic sample after injection in the mobile phase, and comprises an initial dimension sample separation unit (such as a chromatographic separation column) configured for separating the fluidic sample upstream of the purity detector. Correspondingly, the subsequent dimension sample separation device may comprise a subsequent dimension fluid drive unit (such as a high-pressure mobile phase pump) configured for driving further mobile phase and the separated fluidic sample after injection in the further mobile phase, and comprises a subsequent dimension sample separation unit (such as a chromatographic separation column) configured for further separating the separated fluidic sample downstream of the purity detector. In the context of this application, the term “fluid drive unit” may particularly denote any kind of pump which is configured for conducting a mobile phase and/or a fluidic sample along a fluidic path. A corresponding liquid supply system may be configured for metering two or more liquids in controlled proportions and for supplying a resultant mixture as a mobile phase. It is possible to provide a plurality of solvent supply lines, each fluidically connected with a respective reservoir containing a respective liquid, a proportioning valve interposed between the solvent supply lines and the inlet of the fluid drive, the proportioning valve configured for modulating solvent composition by sequentially coupling selected ones of the solvent supply lines with the inlet of the fluid drive, wherein the fluid drive is configured for taking in liquids from the selected solvent supply lines and for supplying a mixture of the liquids at its outlet. More particularly, the first fluid drive can be configured to conduct the fluidic sample, usually mixed with a mobile phase (solvent composition), through the first separation unit, whereas the second fluid drive can be configured for conducting the fluidic sample, usually mixed with a further mobile phase (solvent composition), after treatment by the first separation unit through the second separation unit. The term “separation unit” may particularly denote a fluidic member through which a fluidic sample is transferred and which is configured so that, upon conducting the fluidic sample through the separation unit, the fluidic sample will be separated into different groups of molecules or particles (called components or sub-components, respectively). An example for a separation unit is a liquid chromatography column which is capable of adsorbing and selectively releasing different components of the fluidic sample.

In an embodiment, the subsequent dimension sample separation device comprises a subsequent dimension detector configured for detecting the further separated fluidic sample downstream of the subsequent dimension sample separation unit. Such a detector may operate on the basis of an electromagnetic radiation detection principle. For example, an electromagnetic radiation source may be provided which irradiates the sample passing through a flow cell with primary electromagnetic radiation (such as optical light or ultraviolet light). In response to this irradiation with primary electromagnetic radiation, there will be an interaction of this electromagnetic radiation with the fluidic sample so that resulting secondary electromagnetic radiation may be detected being indicative of the concentration and kind of fluidic components. For instance, the subsequent dimension detector may be embodied as a fluorescence detector with light source, light detector, and a flow cell through which the further separated fluidic sample flows and is detected during flowing. Alternatively, the subsequent dimension detector may also be another type of detector, such as a mass spectrometry detector.

In an embodiment, the method comprises further separating said portion of the fluidic sample on which purity has been detected in-line. In other words, the physically same sample section can be used for the purity detection and thereafter for the further separation in a subsequent dimension sample separation device in an in-line operation of the sample separation apparatus. Thereby, the detected sample itself may be directed in-line into the subsequent dimension sample separation device for further separation. A time-consuming off-line analysis by a user can thus be prevented as well as a modification of the sample characteristics between purity detection and further separation.

In an embodiment, the fluidic valve forming the sampling valve may comprise a first valve member and a second valve member being movable, particularly being rotatable, relative to one another to thereby adjust different operation modes (for instance a first operation mode, in which the separated fluidic sample is further separated in the subsequent separation dimension, or a second operation mode in which the already separated fluidic sample is not further separated but is processed in another way) of the sample separation apparatus. Particularly, when such a fluidic valve is configured as a rotary valve, it may be constituted by a stator and a rotor both having fluid conduits. By rotating the rotor relative to the stator, a desired operation mode may be adjusted. Such a valve may be configured as a shear valve which comprises a first shear valve member as a stator, and a second shear valve member as a rotor. By rotating the second shear valve member, the first and second shear valve member can be moved with respect to each other. The first shear valve member comprises a plurality of ports. A fluid conduit such as a capillary, for instance a glass or metal capillary, can be coupled to each port, respectively.

In an embodiment, the first valve member comprises one or more ports forming fluidic interfaces, and the second valve member comprise one or more fluidic channels (preferably grooves) for fluidically coupling different ports depending on a switching state of the fluidic valve. Thus, a fluid flow may be enabled between an inlet port, a certain one of the fluidic channels and an outlet port. By rotating the fluidic channels along the arrangement of the ports, different fluid communication and paths can be adjusted, while disabling flow along other paths.

In an embodiment, at least one of the initial dimension fluid drive and the subsequent dimension fluid drive is a binary fluid pump. The term “binary fluid pump” may particularly relate to a configuration in which the fluid pump pumps a corresponding mobile phase with a composition of two components. For example, when such a solvent composition is used for a chromatography gradient run, the ratio between water as a first solvent and acetonitrile (ACN) as a second solvent may be adjusted so as to trap and later release individual components on a chromatography column. However, other pumps such as a quaternary pump may be used as well.

In an embodiment, the sample separation apparatus comprises a sample injector for injecting the fluidic sample into a mobile phase and being arranged between the initial dimension fluid drive and the initial dimension separation unit. In such a sample injector, an injection needle may suck a metered amount of fluidic sample into a connected sample loop. After driving and inserting such an injection needle in a corresponding seat and upon switching a fluid injection valve, the fluidic sample may be injected into the path between first fluid drive and first separating unit. Upon such a switching operation, a mobile phase transported by the fluid drive and constituted by a solvent composition may be mixed with the fluidic sample.

In an embodiment, the initial dimension separation unit and/or the subsequent dimension separation unit may be configured for performing a separation in accordance with liquid chromatography, supercritical-fluid chromatography, and gas chromatography. However, alternative separating technologies (such as capillary electrochromatography, electrophoresis) may be applied as well.

The initial and/or subsequent dimension separation unit may be filled with a separating material. Such a separating material which may also be denoted as a stationary phase may be any material which allows an adjustable degree of interaction with a sample so as to be capable of separating different components of such a sample. The separating material may be a liquid chromatography column filling material or packing material comprising at least one of the group consisting of polystyrene, zeolite, polyvinylalcohol, polytetrafluorethylene, glass, polymeric powder, silicon dioxide, and silica gel, or any of above with chemically modified (coated, capped, etc.) surface. However, any packing material can be used which has material properties allowing an analyte passing through this material to be separated into different components, for instance due to different kinds of interactions or affinities between the packing material and components of the analyte.

At least a part of the initial and/or subsequent dimension separation unit may be filled with a fluid separating material, wherein the fluid separating material may comprise beads having a size in the range of essentially 0.1 μm to essentially 50 μm. Thus, these beads may be small particles which may be filled inside the separation section of the microfluidic device. The beads may have pores having a size in the range of essentially 0.01 μm to essentially 0.2 μm. The fluidic sample may be passed through the pores, wherein an interaction may occur between the fluidic sample and the surface of the pores.

The sample separation apparatus may be configured as an analytical fluid separation system for separating components of the sample, i.e. as an analytical sample separation apparatus. When a mobile phase including a fluidic sample passes through the fluidic device, for instance by applying a high pressure, the interaction between a filling of the column and the fluidic sample may allow for separating different components of the sample, as performed in a liquid chromatography device.

However, the sample separation apparatus may also be configured as a fluid purification system for purifying the fluidic sample, i.e. as a preparatory sample separation apparatus. By spatially separating different components of the fluidic sample, a multi-component sample may be purified, for instance a protein solution. When a protein solution has been prepared in a biochemical lab, it may still comprise a plurality of components. If, for instance, only a single protein of this multi-component liquid is of interest, the sample may be forced to pass the columns. Due to the different interaction of the different protein components with the filling of the column (for instance using a gel electrophoresis device or a liquid chromatography device), the different samples may be distinguished, and one sample or band of material may be selectively isolated as a purified sample.

The sample separation apparatus may be implemented in different technical environments, like a sensor device, a test device, a device for chemical, biological and/or pharmaceutical analysis, a capillary electrophoresis device, a capillary electrochromatography device, a liquid chromatography device, a gas chromatography device, an electronic measurement device, or a mass spectroscopy device. Particularly, the fluidic device may be a High Performance Liquid device (HPLC) device by which different components of an analyte may be separated, examined, and/or analyzed.

The sample separation apparatus may be configured to conduct the mobile phase through the system with a high pressure, particularly of at least 600 bar, more particularly of at least 1200 bar.

The sample separation apparatus may be configured as a microfluidic device. The term “microfluidic device” may particularly denote a fluidic device as described herein which allows to convey fluid through microchannels having a dimension in the order of magnitude of less than 500 μm, particularly less than 200 μm, more particularly less than 100 μm or less than 50 μm or less. The sample separation apparatus may also be configured as a nanofluidic device. The term “nanofluidic device” may particularly denote a fluidic device as described herein which allows to convey fluid through nanochannels having even smaller dimensions than the microchannels.

### BRIEF DESCRIPTION OF DRAWINGS

Other objects and many of the attendant advantages of embodiments of the present invention will be readily appreciated and become better understood by reference to the following more detailed description of embodiments in connection with the accompanying drawings. Features that are substantially or functionally equal or similar will be referred to by the same reference signs.

FIG. 1 illustrates a liquid chromatography system according to an exemplary embodiment.

FIG. 2 illustrates a multidimensional sample separation apparatus according to an exemplary embodiment.

FIG. 3 illustrates an absorption peak captured after a first separation dimension of a sample separation apparatus according to an exemplary embodiment.

FIG. 4 illustrates wavelength spectra captured at three temporal positions of the absorption peak of FIG. 3 for determining a purity of a separated fluidic sample portion according to an exemplary embodiment.

FIG. 5 illustrates a mass spectrometry diagram captured at a certain temporal position of the absorption peak of FIG. 3 for determining a purity of a separated fluidic sample portion according to an exemplary embodiment.

FIG. 6 illustrates another mass spectrometry diagram captured at a different temporal position of the absorption peak of FIG. 3, in comparison to FIG. 5, for determining a purity of a separated fluidic sample portion according to an exemplary embodiment.

FIG. 7 illustrates diagrams for explaining sample portion-specific decisions concerning multi-dimensional separations made individually for different fluidic sample portions based on a sample portion-specific purity analysis by means of chromatograms according to an exemplary embodiment.

FIG. 8 shows a fluidic interface region between a primary stage sample separation device and a secondary stage sample separation device according to an exemplary embodiment in which a modulator valve cooperates with two buffer valves each cooperating with a plurality of buffer volumes for temporarily storing a respective fluid packet.

The illustration in the drawing is schematic.

### DETAILED DESCRIPTION

Before describing the figures in further detail, some basic considerations of the present invention will be summarized based on which exemplary embodiments have been developed.

According to an exemplary embodiment of the invention, an eluate from a first or primary separation stage of a sample separation apparatus may be made subject to a spectral analysis or mass spectrometry analysis for recording an eluate spectrum based on a chromatographic peak. Based on a time resolution of such a peak of such a chromatogram, the purity of the section of fluidic sample relating to said peak may be determined. For example, it is possible to record one or multiple optical spectra around the peak. Said one or multiple optical spectra may be compared with one or multiple predetermined reference spectra and/or potential changes of the spectra over time may be observed. On the basis of such analysis, it is possible to determine whether the sample section corresponding to the peak includes a pure substance or a mixture of different substances. If the sample section is pure, no further separation in the subsequent separation dimension is necessary, so that the sample section may be fractionated at an outlet of the first separation dimension. If the sample section is not pure but is still composed of multiple components, said sample section may be guided to the second separation dimension for further separation. By taking this measure, unnecessary further separation processes may be avoided, and the time needed for a precise sample separation may be reduced. Furthermore, hardware resources may be used more efficiently. For example, a spectral impurity of a peak may be used as a basis for cutting out a corresponding section of the fluidic sample separated in the first separation dimension in a heart cutting mode, i.e. making selectively such a fluidic sample section subject to a further separation. Highly advantageously, it may be possible to measure sample section purity online and decide live or in real-time whether a presently passing sample section should be directly guided to the subsequent separation dimension for further separation or should not be further separated in the subsequent separation dimension, since it is already pure or sufficiently pure.

In an embodiment, a purity-based multidimensional chromatography apparatus is provided which is configured for controlling sample separation to be carried out in a number of dimensions, which number is determined by a purity detection of the already separated sample separation in a preceding separation stage or dimension and before forwarding the separated sample for further separation into a subsequent separation stage or dimension. Such an embodiment, when configured for in-line operation, may overcome limitations of offline workflows, i.e. a potential loss of sample (for instance due to degradation, adsorption, etc.). Furthermore, such a purity-based multi-dimensional chromatography apparatus may speed-up the analysis, since it may prevent unnecessary further separation of an already completely (or sufficiently) separated fluidic sample. Furthermore, a purity detection at an interface between adjacent dimensions of a multidimensional sample separation apparatus may allow to gain information for improving control of a sample operation task. In particular, exemplary embodiments of the invention may result in an increased efficiency of multidimensional sample separation, in particular two-dimensional liquid chromatography (2D-LC) or two-dimensional gas chromatography (2D-GC).

A conventional peak-based operation lacks an access to relevant information. Comprehensive 2D-LC is often not sufficient for achieving required resolution.

An exemplary embodiment of the invention provides a sample separation apparatus, which may be preferably embodied as 2D-LC (or 2D-GC), with increased resolution by finding out if compounds have been separated sufficiently.

Generally, operation of a two-dimensional sample separation apparatus can be done in a heart-cutting mode or in a comprehensive mode. In a comprehensive mode, the entire eluent of the first separation dimension is injected to the second separation dimension for further or more refined separation. However, the analysis time is frequently short and may be too short for achieving superior resolution. Heart-cutting allows increasing this resolution, but is limited to one or a limited number of positions in the first dimension separation. For unknown samples, first dimension retention times are not known, or additional peaks may show up unexpectedly. In that case, peak-based operation can be applied.

However, it has been found by the present inventor that peak-based operation usually re-analyzes cuts in the second dimension based on the criterion “is there a peak” rather than based on the more relevant criterion “is there a peak with multiple compounds”, i.e. based on whether or not a sample portion relating to a peak is pure. For instance, a sample portion can be considered as pure if it includes only one component or fraction. Such information may be typically extracted after the separation, i.e. during data analysis and therefore off-line. Algorithms are in place for determining peak purity by using an ultraviolet detector or mass spectral information. It can be determined whether the spectrum changes within a peak, or whether different wavelengths are absorbed. It can further be determined whether different masses are measured.

According to an exemplary embodiment of the invention, a purity determination can be done within the firmware of a purity detector with spectral capabilities (for instance a diode array detector, a fluorescence detector, and/or a mass spectrometry detector) at an outlet of the first separation dimension, such that an on-line or in-line decision concerning a potential further analysis or separation in the second dimension may be performed. This may advantageously avoid (offline) re-injection and re-analysis with intermediate user interaction and data analysis. Advantageously, an exemplary embodiment may use a spectral analysis of peaks which does not influence or reduce the amount of sample.

More specifically, an exemplary embodiment of the invention provides a two-dimensional liquid chromatography apparatus, wherein a decision process which portions separated by the first dimension should go into the second dimension for further separation may be made on the basis of a purity detection. Hence, a gist of an exemplary embodiment of the invention is to analyze purity of peaks—detected in the first dimension—and to decide based on the result of such a purity analysis whether a further separation in the second dimension makes sense and shall be made.

Exemplary embodiments of the invention are particularly appropriate also for a multi-dimensional use. In other words, the principle described above can be applied to more than two dimensions, for instance ultimately doing or repeating separations until peaks are measured to be pure or at least sufficiently pure.

While an optimum resolution may be achieved by different and ideally orthogonal separation conditions in the first separation dimension versus the second separation dimension, an improved separation can also be obtained by using longer run times but the same mobile phase and/or stationary phase. Therefore, the described mechanism can be advantageously used for dynamically extending run times, in particular exactly whenever needed. Advantageously, an exemplary embodiment of the invention foresees online detection of peak purity and automated heart-cutting on the basis of an outcome of the purity detection.

Preferred embodiments of the invention relate to analytical workflows. However, other embodiments can be applied to on-line purification workflows for separation to pure components.

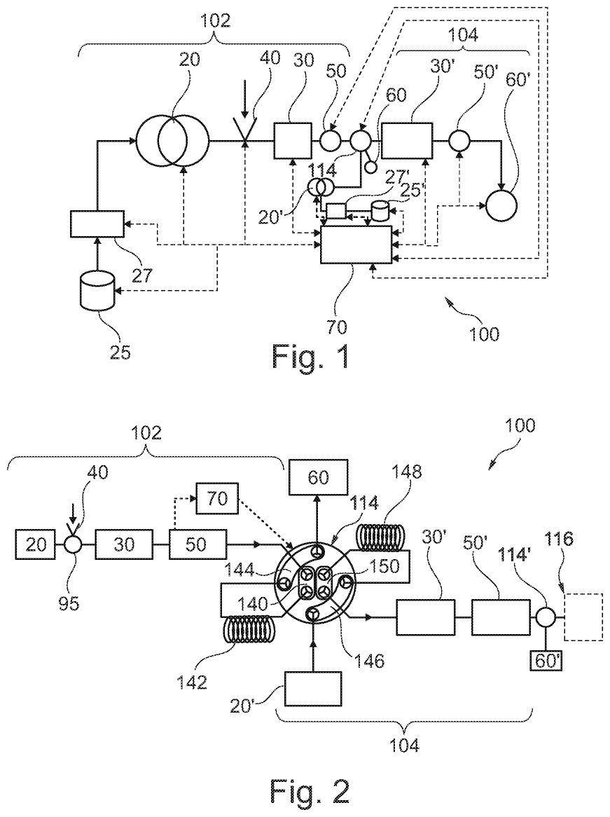

Referring now in greater detail to the drawings, FIG. 1 depicts a general schematic of a two-dimensional liquid separation system as an example for a sample separation apparatus 100 according to an exemplary embodiment of the invention. A first pump in form of a first fluid drive unit 20 receives a mobile phase (also denoted as fluid) from a first solvent supply 25, typically via a first degasser 27, which degases and thus reduces the amount of dissolved gases in the mobile phase. The first fluid drive unit 20—as a mobile phase drive—drives the mobile phase through a first sample separation unit 30 (such as a chromatographic column) comprising a stationary phase. A sampling unit or injector 40 can be provided between the first fluid drive unit 20 and the first sample separation unit 30 in order to subject or add (often referred to as sample introduction) a sample fluid (also denoted as fluidic sample) into the mobile phase. The stationary phase of the first sample separation unit 30 is configured for separating compounds of the sample liquid. The components of the separated fluidic sample can be detected by a detector 50. The detector 50 is provided for detecting separated compounds of the sample fluid.

Simultaneously, detector 50 functions as a purity detector configured for detecting purity of individual peaks in a chromatogram of the fluidic sample separated in first sample separation unit 30. Detector 50 is controlled by a control unit 70 and transmits detection signals to control unit 70. Members 25, 27, 20, 40, 30 and 50 relate to a first dimension sample separation device 102.

A second pump or second fluid drive unit 20′ receives another mobile phase (also denoted as fluid) from a second solvent supply 25′, typically via a second degasser 27′, which degases and thus reduces the amount of dissolved gases in the other mobile phase. By a fluidic valve 114, the first dimension (reference numerals 20, 30, . . . ) of the two-dimensional liquid chromatography system of FIG. 1 may be fluidically coupled to the second dimension (reference numerals 20′, 30′, . . . ). In a second sample separation unit 30′, the pre-separated components of fluidic sample from the first separation dimension may be further separated. The further separated fluidic sample may be detected in a further detector 50′ and may be optionally fractionated in a fractionator 60′. Members 25′, 27′, 20′, 30′, 50′, 60′ constitute a second dimension sample separation device 104.

The fluidic sample is separated into multiple components by the first dimension, and each component can be further separated into multiple sub-components by the second dimension, when the fluidic valve 114 is switched under control of control unit 70 to introduce the separated fluidic sample from the first dimension into the second dimension. However, it is also possible that the fluidic valve 114 is switched under control of control unit 70 to direct the separated fluidic sample from the first dimension to a fractionating unit 60 (or to a waste line) rather than for further separation in the second dimension. The fractionating unit 60 can be provided for outputting separated compounds of sample fluid. More specifically, if purity detector 50 detects that a sample section as an eluate of the first separation dimension only includes a single component and is therefore pure, the control unit 70 uses this detection result for switching fluidic valve 114 so that said sample section is directly fractionated rather than further separated. If however purity detector 50 detects that a sample section as an eluate of the first separation dimension is still a mixture of multiple components or sub-components and is therefore impure, the control unit 70 uses this detection result for switching fluidic valve 114 so that said sample section is further separated in the second separation dimension.

While each of the mobile phases can be comprised of one solvent only, it may also be mixed from plural solvents. Such mixing may be a low pressure mixing and provided upstream of the fluid drive units 20, 20′, so that the respective fluid drive unit 20, 20′ already receives and pumps the mixed solvents as the mobile phase. Alternatively, the fluid drive unit 20, 20′ may be comprised of plural individual pumping units, with plural of the pumping units each receiving and pumping a different solvent or mixture, so that the mixing of the mobile phase (as received by the respective sample separation unit 30, 30′) occurs at high pressure and downstream of the fluid drive unit 20, 20′ (or as part thereof). The composition (mixture) of the mobile phase may be kept constant over time, the so called isocratic mode, or varied over time, the so called gradient mode.

Control unit 70, which can be embodied as a data processing unit (e.g., a computing device) such as a conventional PC or workstation, may be coupled (as indicated by the dotted arrows) to one or more of the devices in the sample separation apparatus 100 in order to receive information and/or control operation. For example, the control unit 70 may control operation of the fluid drive units 20, 20′ (for example setting control parameters) and receive therefrom information regarding the actual working conditions (such as output pressure, flow rate, etc. at an outlet of the pump). The control unit 70 may also control operation of the solvent supply 25, 25′ (for instance setting the solvent/s or solvent mixture to be supplied) and/or the degasser 27, 27′ (for instance setting control parameters such as vacuum level) and may receive therefrom information regarding the actual working conditions (such as solvent composition supplied over time, flow rate, vacuum level, etc.). The control unit 70 may further control operation of the sampling unit 40 (for instance controlling sample injection or synchronization of sample injection with operating conditions of the fluid drive unit 20). The respective sample separation unit 30, 30′ may also be controlled by the control unit 70 (for instance selecting a specific flow path or column, setting operation temperature, etc.), and send—in return—information (for instance operating conditions) to the control unit 70. Accordingly, the detector 50 may be controlled by the control unit 70 (for instance with respect to spectral or wavelength settings, setting time constants, start/stop data acquisition), and send information (for instance about the detected sample compounds) to the control unit 70. The control unit 70 may also control operation of the fluidic valve 114 (for instance in conjunction with data received from the detector 50) and provides data back.

The sample separation apparatus 100 illustrated in FIG. 1 may be operated for separating a fluidic sample selectively in one or two separation dimensions. More specifically, the sample separation apparatus 100 may be operated for deciding individually for each portion of fluidic sample separated in the first separation dimension whether the respective portion of fluidic sample is or is not to be further separated in the second separation dimension. For this purpose, it may be possible to detect data or information indicative of a purity of each individual separated portion of the fluidic sample at the outlet of the first separation dimension by detector 50. Furthermore, control unit 70 may control individually for each separated portion of the fluidic sample whether or not further separation of the separated fluidic sample will be carried out or not in the second separation dimension depending on detected purity information. For instance, a respective separated portion of fluidic sample having a purity above a predefined threshold value may be disabled to enter the second separation dimension. In contrast to this, a respective separated portion of fluidic sample having a purity below the predefined threshold value may be enabled to enter the second separation dimension for further separation.

In the following, referring to FIG. 2, a multidimensional liquid chromatography apparatus 100 according to an exemplary embodiment of the invention will be explained. The illustrated liquid chromatography apparatus 100 may be configured for analytic sample separation or for preparative sample separation.

The illustrated sample separation apparatus 100 is configured for separating a fluidic sample, in particular a liquid sample (or a gas sample, when the sample separation apparatus 100 is configured as gas chromatography apparatus). The shown sample separation apparatus 100 comprises a first dimension sample separation device 102 configured for separating the fluidic sample. In a second dimension sample separation device 104, it may be possible to further separate the separated fluidic sample received from the first dimension sample separation device 102. In an optional third dimension sample separation device 116 (which is shown only schematically), it may be possible to further separate the further separated fluidic sample received from the second dimension sample separation device 104, if desired or required. For example, construction of the third dimension sample separation device 116 may be the same or similar as construction of second dimension sample separation device 104.

As shown, the first dimension sample separation device 102 comprises a first dimension fluid drive unit 20 (such as a high-pressure mobile phase pump) configured for driving mobile phase (such as a solvent or a solvent composition) and the fluidic sample after injection by an injector 40 in the mobile phase. The injector 40 may comprise an injection valve 95 which may be switched into the flow path between first dimension fluid drive unit 20 and first dimension sample separation unit 30 for sample injection. The first dimension sample separation unit 30 (such as a chromatographic column) is configured for separating the fluidic sample in the mobile phase received from the first dimension fluid drive unit 20 and from the injector 40.

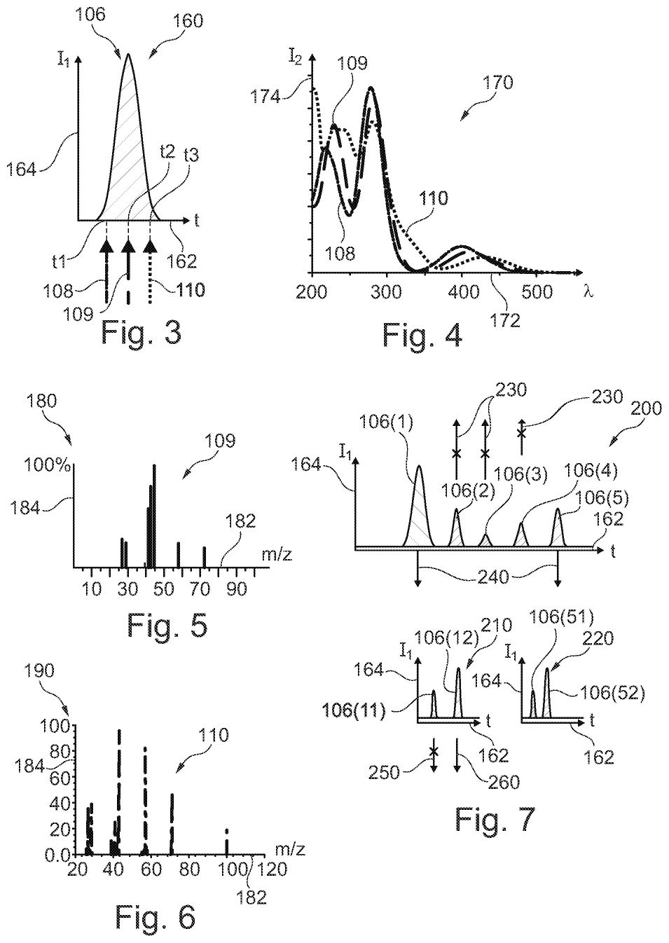

A detector 50 arranged downstream of the first dimension sample separation unit 30 fulfills a double function: On the one hand, detector 50 detects separated components of the fluidic sample in subsequent portions of the fluidic sample flowing through the conduits of the first dimension sample separation device 102. On the other hand, detector 50 is configured as purity detector for detecting information indicative of a purity of a respective portion of the fluidic sample separated by the first dimension sample separation device 102. Descriptively speaking, detector 50 therefore also delivers information to control unit 70 regarding whether a respective fluidic sample portion consists of only one component (and can thus be considered as pure) or is still a mixture of multiple different components at the outlet of the first dimension sample separation device 102 (and can thus be considered as impure). In other words, the purity detector 50 is configured for detecting whether each individual separated portion of the fluidic sample comprises only one pure component or is composed of multiple components. The purity detector 50 can make this conclusion by detecting and evaluating a chromatogram. Preferably, the purity detector 50 is a non-destructive detector configured for analyzing the fluidic sample without destroying the fluidic sample during the detection process. For this purpose, the purity detector 50 may advantageously comprise a spectral analysis detector configured for carrying out a spectral analysis with the portion of the fluidic sample (compare FIG. 3 and FIG. 4).

If the purity detector 50 is alternatively a destructive detector, i.e. destroys fluidic sample during the process of detection, the fluidic sample section may be split at a flow splitter (not shown, for instance a fluidic T-piece) into a first part which is directed to the purity detector 50 for purity detection and into a second part which may be used for fractionating or further separation of the second part of the fluidic sample portion. For example, a mass spectrometry detector configured for further analyzing the portion of the fluidic sample by mass spectrometry may be another appropriate choice for detector 50, although a part of the fluidic sample will be destroyed during purity detection. An example for a corresponding analysis is illustrated in FIG. 5 and FIG. 6 in combination with FIG. 3.

As already mentioned, detector 50 may be synergistically configured for detecting components of the fluidic sample separated by the first dimension sample separation device 102, apart from fulfilling the task of purity detection.

Control unit 70 is provided with the purity detection results of detector 50, i.e. with the detected purity data. Control unit 70 is configured for controlling whether or not further separation of fluidic sample separated by the first dimension sample separation device 102 shall be carried out or not by the second dimension sample separation device 104 depending on detected purity information. More specifically, the control unit 70 is configured for triggering further separation of the separated fluidic sample in the second dimension sample separation device 104 if the detected information is indicative of the presence of a plurality of components in the detected portion of the fluidic sample. Furthermore, the control unit 70 is configured for discharging the portion of fluidic sample out of the sample separation apparatus 100 without further separation of the separated fluidic sample in the second dimension sample separation device 104 if the detected information is indicative of a purity of the detected portion of the fluidic sample. In the latter scenario, the analyzed portion of the fluidic sample which has already been separated by the first dimension sample separation device 102 is not further separated in the second dimension sample separation device 104, but is in contrast to this directly forwarded into fractioning unit 60 or alternatively a waste container without further separation. Highly advantageously, the control unit 70 is thus configured for controlling in-line whether or not further separation of fluidic sample separated by the previous first dimension sample separation device 102 is to be carried out by the subsequent second dimension sample separation device 104. Thus, the fluidic sample remains within the flow paths of sample separation apparatus 100 during the processes of sample separation, purity detection and switching of sampling valve 114 (as described below). The decision about further separation in at least one additional separation dimension or discharging separated fluidic sample without further operation in an additional separation dimension can thus be taken in real time and without the need to involve a user into a cumbersome manual purity detection task. For instance, the control unit 70 may be configured for operating the sample separation apparatus 100 in a heart-cutting mode (preferably in a multiple heart-cutting mode) for selectively cutting out from a continuous stream of fluidic sample one or several discrete sections for additional analysis in an additional separation dimension, on the basis of detected purity information. Advantageously, additional sample separation may thus be limited to cases where purity of a fluidic sample section after a first dimension separation is not yet sufficient.

In order to establish the described logic of forwarding or not forwarding individual sample sections for further separation, sampling valve 114 may be arranged at a fluidic interface between the first dimension sample separation device 102 and the second dimension sample separation device 104 and may be switched or operated under control of control unit 70, wherein a switching scheme may be determined in accordance with the detected purity information. More specifically, the control unit 70 is configured for switching the sampling valve 114 depending on the detected purity information.

As shown in FIG. 2 as well, the second dimension sample separation device 104 comprises a second dimension fluid drive unit 20′ (such as a further high-pressure mobile phase pump) configured for driving further mobile phase (such as a further solvent or solvent composition) and the separated fluidic sample after injection via sampling valve 114 in the further mobile phase. A second dimension sample separation unit 30′ (such as a further chromatography column) is configured for further separating the separated fluidic sample received via sampling valve 114 from purity detector 50. Furthermore, the second dimension sample separation device 104 comprises a second dimension detector 50′ configured for detecting the further separated fluidic sample downstream of the second dimension sample separation unit 30′. As detector 50, also detector 50′ may detect purity of the further separated fluidic sample. A decision whether the further separated fluidic sample shall be introduced into the third dimension sample separation device 116 for carrying out yet another separation, or removing the further separated fluidic sample out of the sample separation apparatus 100 after the second dimension separation and into a further fractioning unit 60′ can be taken based on the results of the purity detection by second dimension detector 50′. This decision can be taken in a corresponding way as described above for detector 50. By taking this measure, it can be flexibly decided for each individual fluidic sample section whether a separation in one, two, three or even more separation dimensions shall be carried out. Proper separation accuracy can thus be synergistically combined with a fast and resource saving operation.

Next, construction and operation of sampling valve 114 will be described in further detail: FIG. 2 shows a first switching state of sampling valve 114. In this first switching state, an outlet of detector 50 is fluidically coupled via a first groove 140 in a rotor member of the rotary-type sampling valve 114 and via ports of a stator member of the rotary-type sampling valve 114 with a (first) sample accommodation volume 142 (here embodied as sample loop). Via a second groove 144 in the rotor member and via further ports of the stator member, the sample accommodation volume 142 is brought in fluid communication with fractionating unit 60 (or alternatively a waste container). In this first switching state, the second dimension fluid drive unit 20′ is fluidically coupled via a third groove 146 in the rotor member and via ports of the stator member with a further (or second) sample accommodation volume 148 (here embodied as further sample loop). Via a fourth groove 150 in the rotor member and via further ports of the stator member, the further sample accommodation volume 148 is brought in fluid communication with second dimension sample separation unit 30′ for further separation of a fluidic sample portion which has previously been buffered in further sample accommodation volume 148.

Thus, in the first switching state of sampling valve 114 illustrated in FIG. 2, a section of fluidic sample which has previously been introduced in the further sample accommodation volume 148 is presently separated in the second separation dimension. Another fluidic sample section is presently introduced into the first sample accommodation volume 142. After switching sampling valve 114 in a second switching state (not shown), which differs from FIG. 2 in that the rotor is rotated by 90°, a fluidic sample section in sample accommodation volume 142 may be separated in the second separation dimension, whereas the further sample accommodation volume 148 may be filled with a fresh fluidic sample section. With the shown configuration, a substantially continuous separation operation can be carried out without significant delay time.

However, when a fresh fluidic sample section flows out of detector 50 and in or through a respective sample accommodation volume 142, 148, it may be decided depending on a purity level of an individual fluidic sample section as just detected by detector 50 in combination with a proper switching of sampling valve 114 whether said individual fluidic sample section is further separated in the second dimension sample separation device 104 or is guided to the fractioning unit 60 or to the waste container without secondary separation. More specifically, control unit 70 receives the purity information from detector 50 and switches the sampling valve 114 so that only selected (i.e. not yet sufficiently pure) fluidic sample sections are further separated in the second dimension.

FIG. 3 illustrates an absorption peak 106 of a chromatogram captured by detector 50 according to FIG. 1 or FIG. 2 after a first separation by sample separation apparatus 100 according to an exemplary embodiment. FIG. 4 illustrates three wavelength spectra captured at three temporal positions t1, t2 and t3 of the absorption peak 106 of the chromatogram of FIG. 3 for determining a purity of a separated fluidic sample portion according to an exemplary embodiment.

FIG. 3 shows a diagram 160 having an abscissa 162 along which the time, t, is plotted. Along an ordinate 164, an absorption intensity, I1, is plotted. Absorption peak 106 in diagram 160 can be detected by detector 50 when a specific portion of fluidic sample passes detector 50. FIG. 4 shows a further diagram 170 having an abscissa 172 along which the wavelength of electromagnetic radiation, λ, is plotted in nanometers (nm). Along an ordinate 174, a signal intensity, I2, is plotted. Three characteristic curves 108, 109 and 110 corresponding to absorption peak 106 in diagram 160 can be detected by detector 50 when a specific portion of fluidic sample passes detector 50. Characteristic curve 108 shows the dependency of the signal intensity I2 from a wavelength of electromagnetic detection radiation at a point of time t1 defined in FIG. 3. Characteristic curve 109 shows the dependency of the signal intensity I2 from the wavelength of electromagnetic detection radiation at a point of time I2 defined in FIG. 3. Characteristic curve 110 shows the dependency of the signal intensity I2 from the wavelength of electromagnetic detection radiation at a point of time t3 defined in FIG. 3.

For obtaining diagram 160, the purity detector 50 may detect a chromatogram of the fluidic sample separated in the first separation dimension. This chromatogram includes the absorption peak 106 of FIG. 3 which relates to a specific portion or section of the fluidic sample to be separated. As shown in FIG. 3, the portion of the fluidic sample corresponds to the optical peak 106 which is here a single absorption peak. In addition, detector 50 is configured for further analyzing the optical absorption peak 106 by recording, for instance at the three temporal positions t1, t2 and t3 of the absorption peak 106 of FIG. 3, a respective wavelength spectrum, as shown in FIG. 4. Thus, the purity detector 50 is configured for detecting the purity information by further analyzing the optical peak 106 in terms of a spectral analysis. Each wavelength spectrum describes, for one specific point of time t1, t2 or t3, a dependency of a detected signal amplitude from a wavelength of electromagnetic radiation detected by detector 50. More generally, the purity detector 50 is configured for further analyzing the optical absorption peak 106 by recording the three (or any other appropriate number of) characteristic curves 108 to 110 relating to the optical peak 106 by varying the physical parameter “wavelength” over time.

Based on the diagram 170 in FIG. 4, it can be decided whether the portion of the fluidic sample includes only one component or multiple components, i.e. is pure or not.

If the already separated portion of the fluidic sample is pure, no further separation of this portion of the fluidic sample is necessary. If the already separated portion of the fluidic sample is not pure, further separation of the portion of the fluidic sample is necessary in a subsequent separation stage.

The purity information may be derived from diagram 170 in different ways. If the already separated fluidic sample comprises only one component or species and is therefore pure, the three characteristic curves 108 to 110 would only differ in height, but not in shape. In this scenario, the three characteristic curves 108 to 110 would have constant proportions, i.e. would only differ by a proportionality factor (and possibly by an offset). In the shown example, however, the shapes of the different characteristic curves 108 to 110 are fundamentally different, so that diagram 170 is the fingerprint of a portion of the fluidic sample which still has different components, fractions or species and needs further separation of said different components, fractions or species in a subsequent separation dimension. For instance, the purity detector 50 is configured for assuming purity of the portion of the separated fluidic sample if the plurality of characteristic curves 108 to 110 differ concerning their shapes by less than a predefined threshold. By taking this measure, relatively small shape differences between the various characteristic curves 108 to 110, which have their origin not in different species in the assigned fluidic sample portion, but in measurement artifacts will not result in an incorrect classification of a pure fluidic sample portion as impure.

Alternatively, a respective one of the characteristic curves 108 to 110 may be compared with a number of preknown reference curves for determining whether one or more characteristic curves 108 to 110 indicate the presence of one or multiple species. For instance, a best match of a characteristic curves 108 to 110 with one of multiple reference curves stored in a database may be searched. When each reference curve of the database is correlated with a certain number (in particular one and more than one) of species in an assigned sample, the found best match may provide purity information.

FIG. 5 and FIG. 6 illustrate different mass spectrometry diagrams 180, 190 captured at two different temporal positions t2, t3 of the absorption peak 106 of FIG. 3 for determining a purity of a separated fluidic sample portion according to an exemplary embodiment.

Each of diagrams 180, 190 has an abscissa 182 along which the mass-electric charge ratio (m/z) is plotted. Along an ordinate 184, a relative abundance is plotted in percent. Two characteristic curves 109 and 110 corresponding to absorption peak 106 in diagram 160 of FIG. 3 can be detected by detector 50, which is here embodied as mass spectrometer detector, when a specific portion of fluidic sample passes detector 50. Characteristic curve 109 shows the dependency of the relative abundance from the mass-electric charge ratio at a point of time t2 defined in FIG. 3. Characteristic curve 110 shows the dependency of the relative abundance from the mass-electric charge ratio at a point of time t3 defined in FIG. 3. Since the analyzed fluidic sample portion comprises various constituents, the peak ratios in diagrams 180, 190 are different from each other. Thus, purity information can also be derived from a comparison of the diagrams 180, 190.

FIG. 7 illustrates diagrams 200, 210, 220 plotted for explaining sample portion-specific decisions concerning single- or multi-dimensional separations made individually for different fluidic sample portions based on a sample portion-specific purity analysis by means of chromatograms according to an exemplary embodiment.

FIG. 7 shows diagrams 200, 210, 220 each having an abscissa 162 along which the time, t, is plotted. Along an ordinate 164, an absorption intensity, 11, is plotted, as in FIG. 3. Absorption peaks 106(1), 106(2), 106(3), 106(4), 106(5), in diagram 200 can be detected by detector 50 at an outlet of a first dimension sample separation device 102 when five subsequent (or successive) portions of fluidic sample pass detector 50 one after the other. For each of the absorption peaks 106(1), 106(2), 106(3), 106(4), 106(5), an analysis as shown in FIG. 4 and/or an analysis according to FIG. 5 and FIG. 6 can be carried out for determining purity information individually for each of the five subsequent (or successive) portions of the fluidic sample. In the shown embodiment, analysis of the absorption peaks 106(2), 106(3), 106(4) provides the information that the three corresponding fluidic sample portions are all pure, i.e. each contains only a single component. Consequently, no further separation of these three fluidic sample portions in a subsequent second separation dimension is carried out, which is shown schematically by reference signs 230. In contrast to this, analysis of the absorption peaks 106(1) and 106(5) provides the information that the two corresponding fluidic sample portions are not pure, i.e. each contain multiple different components. Consequently, a further separation of these two fluidic sample portions in the subsequent second separation dimension is carried out, which is shown schematically by reference signs 240.

Absorption sub-peaks 106(11), 106(12) (which both correspond to absorption peak 106(1)) in diagram 210 can be detected by detector 50′ at an outlet of the second dimension sample separation device 104 when the two sub portions of fluidic sample pass further purity detector 50′ one after the other. For each of the absorption peaks 106(11), 106(12), an analysis as shown in FIG. 4 and/or an analysis according to FIG. 5 and

FIG. 6 can be carried out for determining purity information individually for each of the two subsequent sub portions of the fluidic sample. In the shown embodiment, analysis of the absorption peak 106(11) provides the information that the absorption peak 106(11) is pure, i.e. contains only a single component. Consequently, no further separation of the absorption peak 106(11) in a subsequent third separation dimension is carried out, which is shown schematically by reference sign 250. In contrast to this, analysis of the absorption peak 106(12) provides the information that the corresponding further separated fluidic sample portion is still not pure, i.e. still contains multiple different components. Consequently, a further separation of this fluidic sample portion in a subsequent third separation dimension is carried out, which is shown schematically by reference sign 260. A similar analysis can be made with absorption sub-peaks 106(51), 106(52) which both correspond to absorption peak 106(5), see diagram 220.

Thus, individual sub portions may be made subject to a third, fourth, etc. separation, and so on.

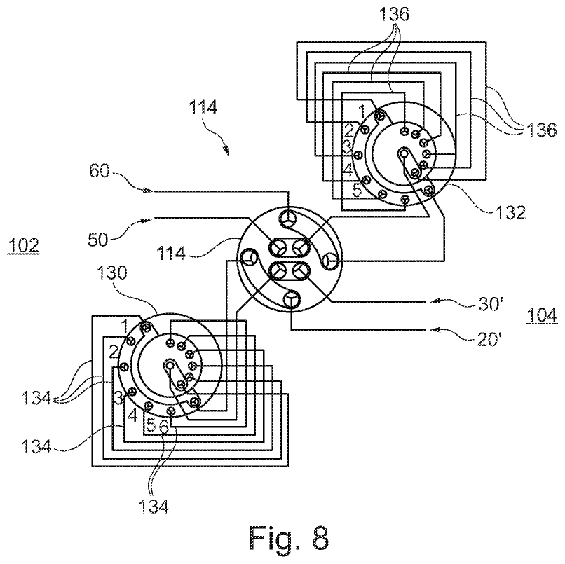

FIG. 8 shows a fluidic interface region between a primary stage sample separation device 102 and a secondary stage sample separation device 104 according to an exemplary embodiment in which a modulator valve 114 cooperates with two buffer valves 130, 132 each cooperating, in turn, with a plurality of buffer volumes 134, 136 for temporarily storing a respective fluid packet. FIG. 8 hence shows an alternative sampling valve configuration, compared with FIG. 2, in which one modulator valve 114 cooperates with two packet parking valves 130, 132 (substituting sample accommodation volumes 142, 148). Each of the packet parking valves 130, 132 serves six buffer volumes 134, 136 (see numbers 1 to 6 at the buffer valves 130, 132). Hence, any desired number of buffer volumes 134, 136 can be implemented following the principle of FIG. 8, so that basically any adaptation of a larger flow rate of the primary stage as compared to a smaller flow rate of the secondary stage is possible.

It should be noted that the term “comprising” does not exclude other elements or features and the term “a” or “an” does not exclude a plurality. Also elements described in association with different embodiments may be combined. It should also be noted that reference signs in the claims shall not be construed as limiting the scope of the claims.

1. A sample separation apparatus for separating a fluidic sample, the sample separation apparatus comprising:
an initial dimension sample separation device configured for separating the fluidic sample in accordance with a first separation criterion;
a subsequent dimension sample separation device configured for further separating separated fluidic sample received from the initial dimension sample separation device in accordance with a second separation criterion;
a purity detector configured for detecting information indicative of a purity of a portion of the fluidic sample which has been separated by the initial dimension sample separation device, wherein the purity is indicative whether the portion of fluidic sample has substantially only a single component or is composed of multiple different components which can be further separated; and
a control unit configured for controlling, depending on the detected information, whether or not further separation of the portion of the fluidic sample which has been separated by the initial dimension sample separation device is carried out by the subsequent dimension sample separation device.

2. The sample separation apparatus according to claim 1, wherein the purity detector is configured for detecting whether the separated portion of the fluidic sample comprises only one pure component or is composed of multiple different components.

3. The sample separation apparatus according to claim 1, wherein the purity detector (50) is configured for detecting whether the separated portion of the fluidic sample comprises only one pure component or is composed of multiple components based on a detected chromatogram.

4. The sample separation apparatus according to claim 1, wherein the purity detector is configured for detecting whether the separated portion of the fluidic sample comprises only one pure component or is composed of multiple components based on an optical peak detected on the separated portion of the fluidic sample.

5. The sample separation apparatus according to claim 4, wherein the purity detector is configured for detecting the information by further analyzing the optical peak.

6. The sample separation apparatus according to claim 5, wherein the purity detector is configured for further analyzing the optical peak by recording and comparing a plurality of characteristic curves all relating to the optical peak and obtained by varying at least one physical parameter over time.

7. The sample separation apparatus according to claim 6, wherein the purity detector is configured for assuming purity of the portion of the separated fluidic sample if the plurality of characteristic curves differ concerning their shapes by less than a predefined threshold.

8. The sample separation apparatus according to claim 5, wherein the purity detector is configured for further analyzing the optical peak by recording at least one characteristic curve relating to the optical peak by varying at least one physical parameter over time, and by comparing at least one characteristic curve with at least one reference curve relating to a reference sample with pre-known properties.

9. The sample separation apparatus according to claim 1, wherein the purity detector is a non-destructive detector configured for analyzing the fluidic sample without destructing the fluidic sample.

10. The sample separation apparatus according to claim 1, wherein the purity detector comprises a spectral analysis detector configured for carrying out a spectral analysis with the portion of the fluidic sample.

11. The sample separation apparatus according to claim 1, wherein the purity detector comprises a mass spectrometry detector configured for analyzing part of the portion of the fluidic sample by mass spectrometry concerning purity, whereas another part of the portion of the fluidic sample is forwarded for further separation to the subsequent dimension sample separation device if the purity detector detects an insufficient purity level for the portion of the fluidic sample.

12. The sample separation apparatus according to claim 1, wherein the purity detector is configured for detecting components of the fluidic sample separated by the initial dimension sample separation device.

13. The sample separation apparatus according to claim 1, wherein the control unit is configured for triggering further separation of the separated portion of the fluidic sample in the subsequent dimension sample separation device if the detected information is indicative of the presence of a plurality of components in the detected portion of the fluidic sample.

14. The sample separation apparatus according to claim 1, wherein the control unit is configured for discharging the separated portion of the fluidic sample out of the sample separation apparatus without further separation of the separated portion of the fluidic sample in the subsequent dimension sample separation device if the detected information is indicative of a purity of the detected portion of the fluidic sample.

15. The sample separation apparatus according to claim 1, wherein the control unit is configured for controlling in-line whether or not further separation of the portion of the fluidic sample, which has been separated by the initial dimension sample separation device, is carried out or not by the subsequent dimension sample separation device.

16. The sample separation apparatus according to claim 1, wherein the control unit is configured for operating the sample separation apparatus in a heart-cutting mode.

17. The sample separation apparatus according to claim 1, comprising at least one of the following features:
configured as a two-dimensional sample separation apparatus;
configured as a as two-dimensional chromatographic sample separation apparatus;
comprising at least one further dimension sample separation device configured for further separating the portion of the fluidic sample, which has been separated by the initial dimension sample separation device and by the subsequent dimension sample separation device, in at least one further separation dimension;
configured as one of an analytic sample separation apparatus or a preparative sample separation apparatus;
comprising a sampling valve at an interface between the initial dimension sample separation device and the subsequent dimension sample separation device, wherein the control unit is configured for switching the sampling valve depending on detected information to thereby control whether or not further separation of fluidic sample which has been separated by the initial dimension sample separation device is carried out by the subsequent dimension sample separation device;
comprising a sampling valve at an interface between the initial dimension sample separation device and the subsequent dimension sample separation device, wherein the control unit is configured for switching the sampling valve depending on detected information to thereby control whether or not further separation of fluidic sample which has been separated by the initial dimension sample separation device is carried out by the subsequent dimension sample separation device, wherein the sampling valve comprises at least one sample accommodation volume, preferably a plurality of sample accommodation volumes, configured for temporarily accommodating a portion of the fluidic sample after separation by the initial dimension sample separation device and before separation by the subsequent dimension sample separation device;
wherein the initial dimension sample separation device comprises an initial dimension fluid drive unit configured for driving mobile phase and the fluidic sample after injection in the mobile phase, and comprises an initial dimension sample separation unit configured for separating the fluidic sample upstream of the purity detector;
wherein the subsequent dimension sample separation device comprises a subsequent dimension fluid drive unit configured for driving mobile phase and the separated fluidic sample after injection in the mobile phase, and comprises a subsequent dimension sample separation unit configured for further separating the separated fluidic sample downstream of the purity detector;
wherein the subsequent dimension sample separation device comprises a subsequent dimension fluid drive unit configured for driving mobile phase and the separated fluidic sample after injection in the mobile phase, and comprises a subsequent dimension sample separation unit configured for further separating the separated fluidic sample downstream of the purity detector, wherein the subsequent dimension sample separation device comprises a subsequent dimension detector configured for detecting the further separated fluidic sample downstream of the subsequent dimension sample separation unit.

18. The sample separation apparatus according to claim 1, comprising at least one of the following features:
at least one of the initial dimension sample separation device and the subsequent dimension sample separation device is configured for performing a separation in accordance with one selected from the group consisting of: liquid chromatography, high-performance liquid chromatography (H PLC), supercritical-fluid chromatography, gas chromatography, capillary electrochromatography, and electrophoresis;
the sample separation apparatus is configured to analyze at least one physical, chemical, and/or biological parameter of at least one compound of the fluidic sample;
the sample separation apparatus is configured to conduct the fluidic sample with a high pressure;
the sample separation apparatus is configured to conduct the fluidic sample with a pressure in a range selected from the group consisting of at least 500 bar, at least 1000 bar, and at least 1200 bar;
the sample separation apparatus is configured to conduct a liquid or a gas;
the sample separation apparatus is configured as a microfluidic device;
the sample separation apparatus is configured as a nanofluidic device.

19. A method of separating a fluidic sample, the method comprising:
separating the fluidic sample in accordance with a first separation criterion;
detecting information indicative of a purity of a portion of the separated fluidic sample, wherein the purity is indicative whether the portion of fluidic sample has substantially only a single component or is composed of multiple different components which can be further separated; and
controlling, depending on the detected information, whether or not further separation of the portion of the separated fluidic sample will be carried out in accordance with a second separation criterion.

20. The method according to claim 19, comprising at least one of the following features:
wherein the method comprises, preferably in an in-line process, further separating said portion of the fluidic sample if an insufficient purity level has been detected for said portion of the fluidic sample;
wherein the method comprises draining off said portion of the fluidic sample away from a further separation path without a further separation if a sufficient purity level has been detected for said portion of the fluidic sample;
wherein the method comprises forwarding at least one separated portion of the fluidic sample to a further separation path for carrying out a further separation and draining at least one other separated portion of the fluidic sample away from the further separation path without a further separation, depending on a respective detected purity level of said separated portions of the fluidic sample.
